(19) United States
(12) Patent Application Publication
(10) Pub. No.: US 2016/0358262 A1
(43) Pub. Date: Dec. 8, 2016

(54) SYSTEM FOR USE OF RETIREMENT FUNDS FOR INVESTMENT

(71) Applicant: Simon Peter JONES, Lennox Head, New South Wales (AU)

(72) Inventor: Simon Peter JONES, Lennox Head, New South Wales (AU)

(21) Appl. No.: 15/037,969

(22) PCT Filed: Nov. 19, 2014
(86) PCT No.: PCT/AU2014/001055

§ 371 Date: May 19, 2016

(30) Foreign Application Priority Data
Nov. 19, 2013 (AU) 2013904450
Mar. 18, 2014 (AU) 2014900949

(51) Int. Cl. G06Q 40/06; H04L 29/06; G06Q 50/16; G06Q 40/08

(52) U.S. Cl. CPC G06Q 40/06; G06Q 40/08; H04L 63/102; G06Q 50/16

(57) ABSTRACT

An electronic management system comprising of digital processors, database storage medium and input and output devices; said system executing software steps in the management of transactions between financial entities; said financial entities including at least an owner/s of a property, a retirement fund of said owner/s and an associated managed fund; said transactions including application by said owner/s for an acquisition by said managed fund of investment equity in said owner/s' property.

Also described is a digital input/output device incorporating means to recognise a physiological feature of a prospective member preparatory to comparing that physiological feature with a database of physiological features for verification of the identity of the member thereby to permit access by the member to the system described above.

### TECHNICAL FIELD

The present invention relates to computer implemented systems for facilitating complex interactions between entities over a distributed communication network such as the Internet.

### BACKGROUND

Superannuation and other forms of retirement or pension funds are well known in the art. Typically these funds represent a way for a user to save for retirement to maintain a level of financial independence. A common problem is that the financial return on these investments has been less than expected often due to the volatile nature of the capital markets that form the basis of the investments made by the funds as they represent the interests of the fund members.

A legal system that allows users to invest their pension or superannuation into their home does not currently exist.

The described invention is designed to address these issues.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

The terms retirement fund, pension fund and superannuation fund used in this specification are synonymous and refer to financial institutions in which funds deposited form an investment for the benefit of a fund member on retirement.

### SUMMARY OF INVENTION

Accordingly, in one broad form of the invention, there is provided an electronic management system comprising of digital processors, database storage medium and input and output devices; said system executing software steps in the management of transactions between financial entities; said financial entities including at least an owner/s of a property, a retirement fund of said owner/s and an associated managed fund; said transactions including application by said owner/s for an acquisition by said managed fund of investment equity in said owner/s' property.

Preferably, said owner/s' property is the personal residence of said owner/s.

Preferably, said associated managed fund is an entity incorporated within said retirement fund.

Preferably, said associated managed fund is a separate entity.

Preferably, said electronic management system is hosted by said retirement fund of said owner/s.

Preferably, said electronic management system is shared between said retirement fund and said associated managed fund; said elements of said system hosted by said associated management fund executing steps of complementary software.

Preferably, said system generates and transmits suitable application input forms to the owner/s over said distributed communication network as pages of a web site maintained by said system.

Preferably, access to an application sequence on said web site is provided to members of said retirement fund through log on security of predefined user name and pass code.

Preferably, said application input forms completed by a owner/s are received by said owner/s retirement fund for processing.

Preferably, application input form data is structured so as to allow automatic processing by said system; software steps executed by said system including provision of checks with error and advice messages to ensure that application data input by an applicant owner/s conforms to that required to effect a valid application.

Preferably, said application input forms provides for additional comments by said applicant owner/s; said software generating an alert to ensure perusal of such non standard or unstructured comments by an operative of said retirement fund.

Preferably, data provided by said owner/s in said application forms is vetted by said software to check that said owner/s is an eligible applicant.

Preferably, an acceptable application causes said software to generate and transmit to said managed fund a request for equity acquisition by said associated managed fund in said owner/s' property.

Preferably, software relevant to said managed fund generates instructions to an investment valuation and verification service for a due diligence and valuation assessment of said owner/s' property.

Preferably, said software generates and transmits to said investment valuation service structured assessment input forms which allow substantially automatic processing of assessment data provided by a due diligence and valuation process.

Preferably, said assessment input forms provide for additional comments by a valuer or other operative; said software generating an alert for consideration of any additional comments by an operative of said managed fund.

Preferably, a recommended investment value said due diligence and valuation assessment together with said application input data provided by said owner/s is processed by said software to derive a proposed equity position in said owner/s' property which said managed fund is prepared to take up.

Preferably, said proposed equity position is transmitted by said software to said owner/s for approval.

Preferably, an approved equity position leads to a reduction in said mortgage requirements or an extinction of said mortgage.

Preferably, a reduction in said mortgage results in registration of a caveat on the title to said property; said caveat representing said equity position taken by said managed fund in said property.

In yet a further broad form of the invention, there is provided an electronic management system comprising of digital processors, database storage medium and input and output devices; said system executing software steps in the management of transactions between financial entities; said financial entities including at least a owner/s of a property, and a retirement fund of said owner/s; said transactions including application by said owner/s for an acquisition by said retirement fund of investment equity in said owner/s' property.

Preferably, said financial entities further include an associated managed fund.

Preferably, said owner/s' property is the personal residence of said owner/s.

In an alternative preferred form, the property is a residence. And yet an alternative preferred form, the property may be a commercial property.

Preferably, said associated managed fund is an entity incorporated within said retirement fund.

Preferably, said associated managed fund is a separate entity.

Preferably, said electronic management system is hosted by said retirement fund of said owner/s.

Preferably, said electronic management system is shared between said retirement fund and said associated managed fund; said elements of said system hosted by said associated management fund executing steps of complementary software.

Preferably, said system generates and transmits suitable application input forms to the owner/s over said distributed communication network as pages of a web site maintained by said system.

Preferably, access to an application sequence on said web site is provided to members of said retirement fund through log on security of predefined user name and pass code.

Preferably, said application input forms completed by an owner/s are received by said owner/s retirement fund for processing.

Preferably, application input form data is structured so as to allow automatic processing by said system; software steps executed by said system including provision of checks with error and advice messages to ensure that application data input by an applicant owner/s conforms to that required to effect a valid application.

Preferably, said application input forms provides for additional comments by said applicant owner/s; said software generating an alert to ensure perusal of such non standard or unstructured comments by an operative of said retirement fund.

Preferably, data provided by said owner/s in said application forms is vetted by said software to check that said owner/s is an eligible applicant.

Preferably, an acceptable application causes said software to generate and transmit to said managed fund a request for equity acquisition by said associated managed fund in said owner/s' property.

Preferably, software relevant to said managed fund generates instructions to an investment valuation and verification service for a due diligence and valuation assessment of said owner/s' property.

Preferably, said software generates and transmits to said investment valuation service structured assessment input forms which allow substantially automatic processing of assessment data provided by a due diligence and valuation process.

Preferably, said assessment input forms provide for additional comments by a valuer or other operative; said software generating an alert for consideration of any additional comments by an operative of said managed fund.

Preferably, a recommended investment value said due diligence and valuation assessment together with said application input data provided by said owner/s is processed by said software to derive a proposed equity position in said owner/s' property which said managed fund is prepared to take up.

Preferably, said proposed equity position is transmitted by said software to said owner/s for approval.

Preferably, an approved equity position leads to a reduction in said mortgage requirements or an extinction of said mortgage requirements.

Preferably, a reduction in said mortgage results in registration of a caveat on the title to said property; said caveat representing said equity position taken by said managed fund in said property.

In an alternative form, security is maintained by a “tenants in common” relationship.

In yet a further broad form of the invention, there is provided a method of financing at least part of a home purchase; said method comprising arranging for a fund to invest in the home on behalf of the owner/s; said fund holding a position of control exercisable at the time of transfer of title on the home.

Preferably, the fund is a superannuation fund.

Preferably, the superannuation fund invests in the home via a managed fund.

Preferably, the position of control is effected by means of a Tenants in Common joint investment.

### BRIEF DESCRIPTION OF DRAWINGS

FIG. 1—Main components of the example embodiment

FIG. 2—Example Property Acquisition Process of example embodiment

FIG. 3—Example Property Sale Process of example embodiment

FIG. 4—is an illustration of a further example of the operation of the invention.

FIG. 5—is an illustration of a further embodiment of the previously described system wherein like components are numbered as for previous embodiments.

FIG. 6—is a process diagram for an acquisition process in accordance with a particular implementation of the system of FIGS. 1, 2 and 3.

FIG. 7—is a diagram of data inputs and outputs for an implementation of the system of FIG. 1.

FIG. 8—is a flow diagram of the registration processes for the system of FIG. 6.

FIG. 9—is a flow diagram of a member request query upon the implementation of FIG. 6.

FIG. 10—is a block diagram of an identity enrolment and verification process and apparatus.

### DESCRIPTION OF EMBODIMENTS

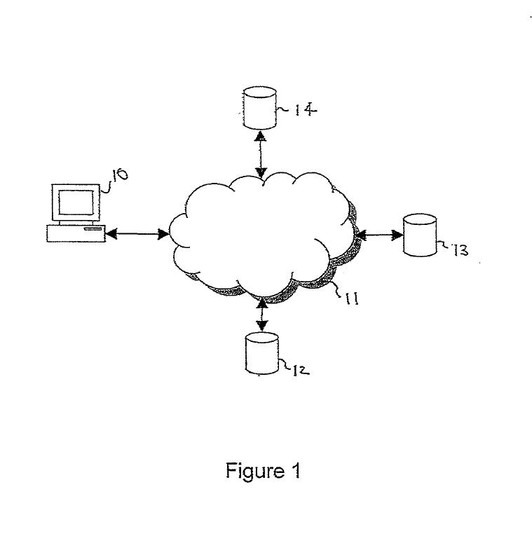

FIG. 1 discloses the main components of the example embodiment. A user or owner/s (prospective or already owning) with or seeking to obtain a mortgage 10 has a contractual relationship with the provider of their superannuation or retirement fund 12. The owner/s may also have an electronic relationship which occurs typically over the Internet 11. A owner/s 10 can also choose to use retirement fund managers 12 who work along with managed investment funds 13 that allow the owner/s 10 to opt in and out of various investments within a portfolio of investments. In this situation it is advisable to have an investment valuation and verification service 14 that can be used to ensure that the investment by the superannuation or retirement fund 13 attains to government and industry regulations and standards relating to operation of superannuation of retirement funds.

In the example embodiment of the invention, a owner/s 10 chooses a retirement fund 12 that works with a managed fund 13 that is willing to purchase equity in the property, that is, the personal residence of the owner/s 10.

The owner/s 10 declare their interest to invest a portion of their retirement funds into their home. This intent is communicated to the managed fund 13 that is working with the manager of the owner/s 10 retirement fund 12.

The managed fund 13 then instructs an investment valuation and verification service 14 to review the home of the owner/s 10 with a view to making a recommendation to the managed fund 13.

If the evaluation proves positive for investment by the investment valuation and verification service 14, the managed fund 13 agrees to purchase a portion of the equity in the property, that is the personal residence of the owner/s 10, equal to or less than the amount of the owner/s 10 mortgage.

Upon successful completion of the transaction, money from the owner/s retirement fund 13 is transferred to the existing mortgagee and a proportion equity position of ownership is transferred to the managed fund 13 on behalf of the retirement fund 12 which now carries an investment in the favour of the member of the retirement fund 12.

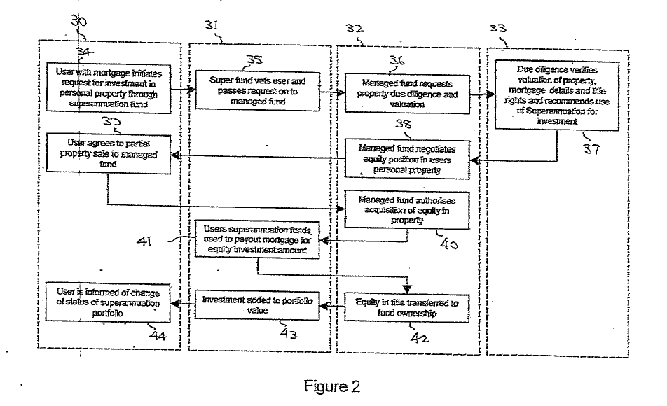

FIG. 2 shows the process involved in acquiring a property using the steps defined by the invention. A owner/s 10 initiates a request 34 to their retirement fund 12 to invest in their own home. The retirement or superannuation fund 12 vets the owner/s' credentials 35 and passes on the request 34 to the managed fund 13 which works in a relationship with the retirement fund 12. In turn the managed fund 13 requests a due diligence and valuation 36 from an investment valuation and verification service 14 that is tasked with evaluating the property of the owner/s 10 with a view to determining if the property is a valid investment under the requirement of the managed fund 13.

If the evaluation fails, then the owner/s 10 is informed and the process terminated.

If the evaluation 37 is successful, the managed fund 32 negotiates 38 an equity position in the home. Subsequently the owner/s 10 may agree to a partial sale of the property 39 to the managed fund 13 and the managed fund 13 initiates 40 a pay out to an existing mortgagee 41 in return for an appropriate equity position in the property 39.

Subsequently the equity position is registered as a partial ownership in the property's title 42 by the managed fund 13. The home is added to the owner/s' portfolio 43 of investments by the owner/s' retirement fund 12 and the owner/s 10 is informed of the changes in their retirement portfolio 44.

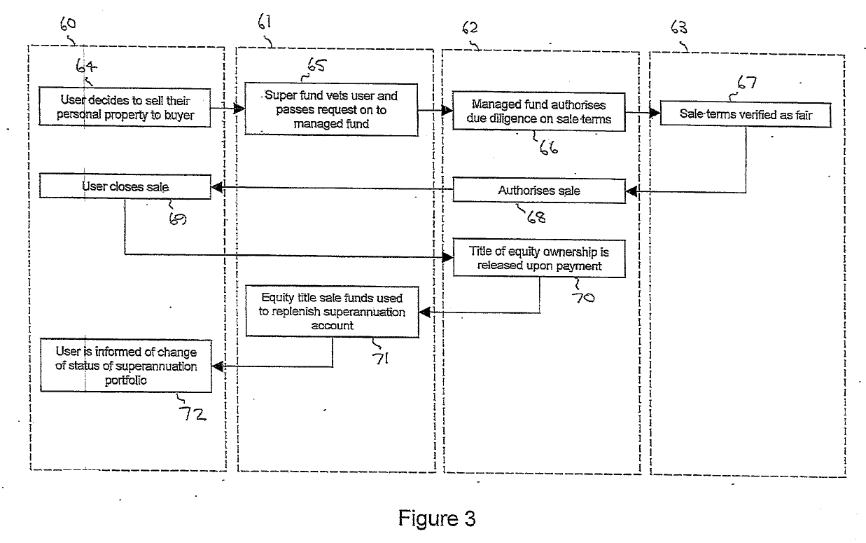

FIG. 3 discloses the process of what happens when an owner/s' property is sold where part of the owner/s' property is owned as an investment by the managed fund 13.

An owner/s 10 decides 64 to sell their personal home. The decision to sell is communicated 65 to their retirement fund 12 which then authorises the managed fund 13 to evaluate 66 the sale terms using a valuation service 14 to ensure the sale terms fit within the legal and industry requirements and standards expected of retirement funds 12 and their partnering managed fund 13. Once the sale terms are verified as fair and reasonable 67 the managed fund 13 authorises the sale of the funds equity position in the home 68 and the owner/s closes the sale. The managed fund 13 releases the title ownership or position upon payment by the buyer 70 and the proceeds are paid to the owner/s' retirement fund 12.

The owner/s is then informed of the changes to their retirement portfolio 72.

The result of the use of the example embodiment allows the owner/s to make use or retirement funds for investment into residential property, especially their home.

### Alternative Embodiments

The example embodiment shows a owner/s using their retirement funds to invest in their own home using or not using title acquisition. An alternative embodiment could see the owner/s' retirement funds being used to facilitate any financial instrument that allows the reduction or replacement of a owner/s' mortgage including but not limited to a loan on the property.

The example embodiment shows the owner/s using a superannuation, retirement or pension fund, working with a separate managed fund and a separate valuation service. An alternative embodiment could see the owner/s working with any superannuation, retirement or pension fund, where the transaction processes of the managed fund is partially or fully included in the role of the superannuation, retirement or pension fund and where the valuation and due diligence services are internal or partially internal services of either the managed fund or the superannuation, retirement or pension fund.

The example embodiment shows the owner/s using their retirement funds to invest in their own home which may replace an mortgage. An alternative embodiment could see the owner/s' retirement funds being invested in their home as a full or partial alternative to a mortgage when initially buying a home.

### Preferred Embodiment

In a preferred embodiment of the invention, the system for use of retirement funds for home investment according to the invention, is implemented as an electronic management system comprising of digital processors, database storage medium and input and output devices. Generally, the system will be hosted by the managed fund 13 as part of a user or owner/s' 10 retirement fund 12, whereby the user or owner/s wishes to make use of their retirement funds for investing into residential property, though in some preferred arrangements, elements of the system may be shared by the retirement fund, an associated managed fund(s) and/or external information technology providers.

Software resident on servers of the system execute steps in the management of transactions between at least some of the financial entities described above, that is a owner/s or mortgagor of a property, a retirement fund of the mortgagor and an associated managed fund.

The software of the system provides a number of functions which include the generation of suitable input forms to the owner/s over a distributed communication network such as the internet as noted above and as illustrated in FIG. 1, as pages of a web site maintained by the system. Access to an application sequence on the web site is provided to members of the retirement fund through the log on security of predefined user name and pass code. Input forms completed by a owner/s are received by the owner/s retirement fund for processing.

Input data is structured so as to allow automatic processing by the system and with the provision within the software of checks with error and advice messages to ensure that data input by an applicant owner/s conforms to that required to effect a valid application. Provision may be provided within the input form for additional comments by the applicant owner/s in which case the software generates an alert to ensure perusal of such non standard or unstructured comments by an operator.

The input provided by an applicant owner/s 10 generates the request 34 shown in FIG. 2. The data included in the request is vetted by the software to check that the owner/s is an eligible applicant. This may include meeting or exceeding a threshold level of funds invested in the retirement fund. The data will further include details of the current financing arrangement of the owner/s' residence, such as the current mortgagee, the current balance, term of the loan and the like.

If the various criteria are met, the software generates a formatted request 35 to the associated managed fund 13. In at least some arrangements, the managed fund 13 may be a managed fund wholly incorporated within the retirement fund 12, in which case the software hosted on the servers and databases of the retirement fund continues with the next step in the processing of the application. Where the associated managed fund is a separate entity, complementary software hosted on its servers and databases takes over the next step in the process.

In either case, the software relevant to the managed fund of the system generates instructions 36 to an investment valuation and verification service 14 for a due diligence and valuation assessment of the owner/s' residence which includes all the necessary details to allow both a physical inspection of the property and access to relevant digital and non digital records. Accompanying these instructions, the software generates structured input forms which allows substantially automatic processing of the assessment data provided by the due diligence and valuation process. As before, the input may provide for additional comments by a valuer or other operative, in which case the software generates an alert for consideration of this input by an operative of the managed fund.

If the due diligence and valuation assessment are satisfactory, a recommended investment value provided by the due diligence and valuation process, together with the input data provided by the owner/s is now used by the software to derive a level of equity in the owner/s' property which the managed fund is prepared to take up. This proposed equity position 38 is transmitted by the software to the owner/s for approval. Typically, the transmission may take the form of an email inviting the owner/s to access the owner/s retirement fund account on the web site where the equity offer may be viewed.

If the offer is acceptable to the owner/s, acceptance is conveyed by a further input form made available by the software. Based on this acceptance the software generates an authorization from the managed fund to proceed with the equity acquisition. The authorization includes the release of funds from the owner/s retirement fund for payment to the current mortgagee.

The system calculates the available balance (preferably up to a maximum of 80% of the user or owner/s total super account, although greater amounts may be allowable) that can be used for investment into their property. This amount is paid to the existing mortgagee upon settlement. Settlement causes the mortgage to be reduced or extinguished completely using the available super funds for investment.

A caveat is registered on the title of the property giving a percentage equity ownership to the super fund. In the event that the property is subsequently sold, a percentage of the proceeds equal to the percentage equity, is retained by the fund.

Where the mortgage is extinguished, its registration is removed. Should re-financing occur, a new mortgagee is registered. In all cases, a caveat noting interest by the fund remains in place until recompense of ownership to the fund in the event of sale. Thus there will arise no instance whereby there is a shortage of funds.

The investment 43 in FIG. 2, refers to the property investment reflected in the user or owner/s' total portfolio asset allocation. Post settlement, the portfolio allocation may appear to the fund member as shown in the table below.

| | | Balance - |
|---|---|---|
| | Current Balance | Post settlement |
| Australian Shares | 0.00% | 0.00% |
| International Shares | 0.00% | 0.00% |
| Australian Property - Unlisted | 0.00% | 80.00% |
| Australian Property - Listed | 0.00% | 0.00% |
| International Property - Listed | 0.00% | 0.00% |
| Growth | 0.00% | 80.00% |
| Aust Fixed Interest | 0.00% | 0.00% |
| Int'l Fixed Interest | 0.00% | 0.00% |
| Aust Cash | 100.00% | 20.00% |
| Int'l Cash | 0.00% | 0.00% |
| Defensive | 100.00% | 20.00% |
| Alternative Assets | 0.00% | 0.00% |

The user of owner/s has the option to invest the remaining 20% of their funds across available asset classes or retain in cash if desired as per most other fund options.

### EXAMPLE

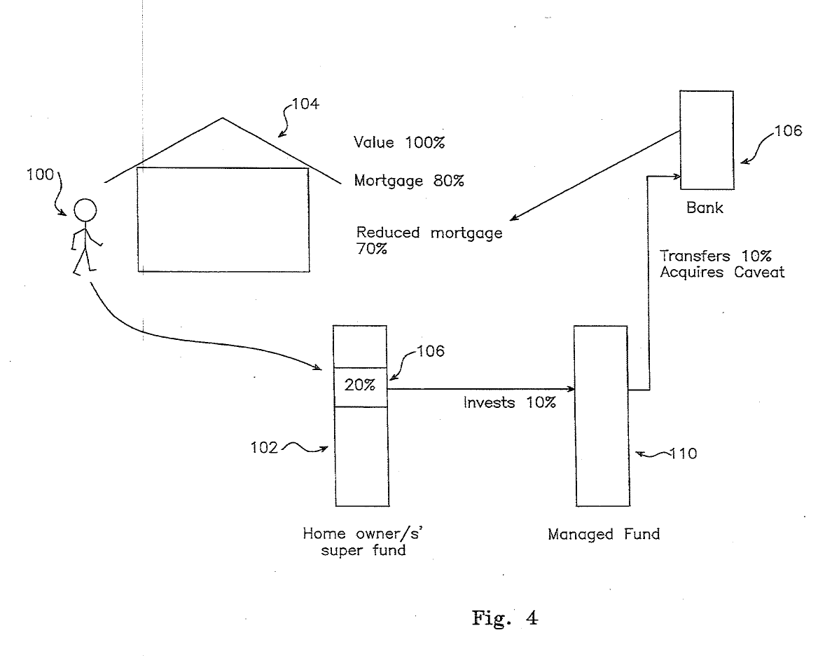

With reference to FIG. 4, a member 100 of a super, retirement or managed fund 102 is the owner of a property 104, value 100%, 80% of which is mortgaged to a mortgagee, typically a bank 106. The member, that is the owner/s 100 has an investment portfolio in the super fund 102 equal in value to 20% of the value of the property 104.

The owner/s 100, by means of the software generated web site pages discussed above, makes an application to the super fund 102 which, subject to the valuation and other criteria discussed above, uses a portion of the owner/s super funds 106 to acquire an investment 108 in a separate managed fund 110, for example, to the value of 10% of the value of the property. This separate managed fund 110 applies the 10% to reducing the mortgage held by the bank 106 from the current liability of 80% to 70% and acquires a 10% equity in the form of a caveat over the title to the property.

In this example only a portion of the value of the owner/s super fund portfolio is used to reduce the mortgage, but it will be understood that the arrangement may serve to discharge the entire mortgage if the portfolio is equal to or greater than the value of the mortgage.

### Further Embodiment

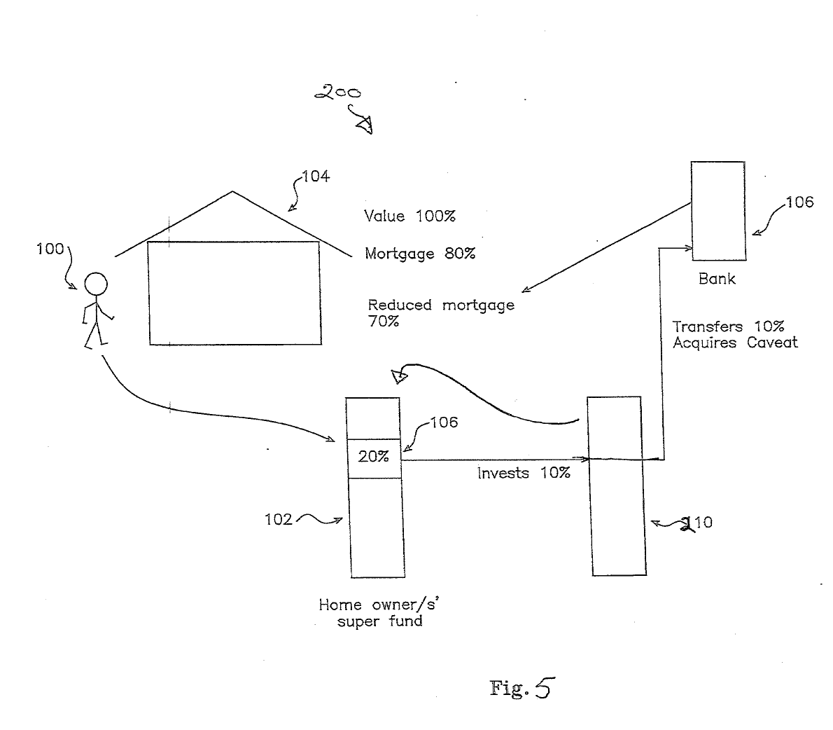

With reference to FIG. 5, there is illustrated a further embodiment of the previously described system wherein like components are numbered as for previous embodiments.

In this instance, the electronic management system 200 according to this embodiment merges the function of the managed fund 110 of previous embodiments directly into the owner's superfund 102. In practice, this can be effected in one version, by the trustee of the owner's superfund 102. The entity 210 invests the funds from the owner's superfund and conducts the transaction 106 in the manner previously attributed to managed fund 110. In this instance the trustee 210 will acquire the caveat over the owner's property 104. In this instance the superfund 102 may take an equity position and/or option in addition to the caveat or instead of the caveat. Broadly then, what is described in this embodiment is an electronic management system comprising of digital processors, database storage medium and input and output devices; said system executing software steps in the management of transactions between financial entities; said financial entities including at least an owner/s of a property, and a retirement fund of said owner/s; said transactions including application by said owner/s for an acquisition by said retirement fund of investment equity in said owner/s' property. Preferably this will be that with a view to a reduced need for a mortgage held by a bank or other investment institution over the owner's property.

### Alternative Embodiments

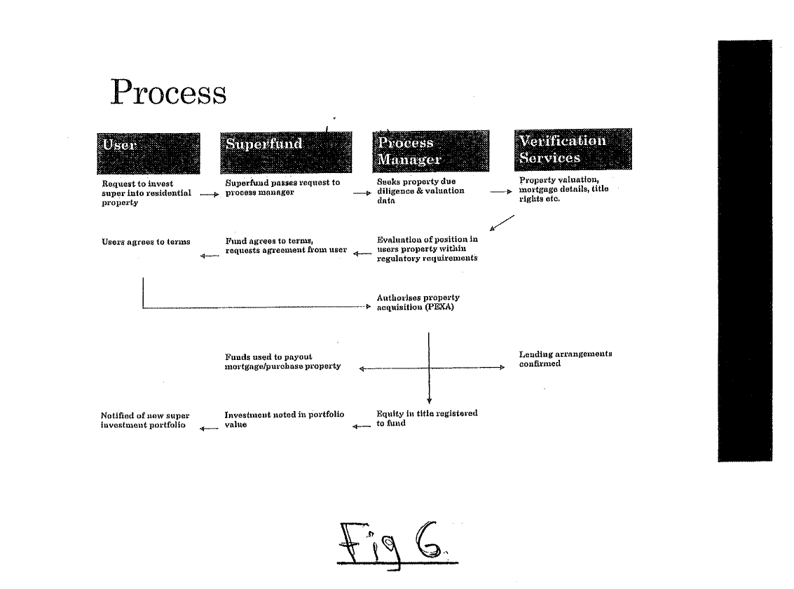

The example embodiment thus far show the owner/s using a superannuation, retirement or pension fund, working with a separate managed fund and a separate valuation service. An alternative embodiment (with reference to FIG. 6) may see the owner/s working with any superannuation, retirement or pension fund, where the managed fund is partially or fully included (or not used at all) in the role of the superannuation, retirement or pension fund and where the valuation and due diligence services are independent services or internal or partially internal services of either the managed fund or the superannuation, retirement or pension fund.

Implementation

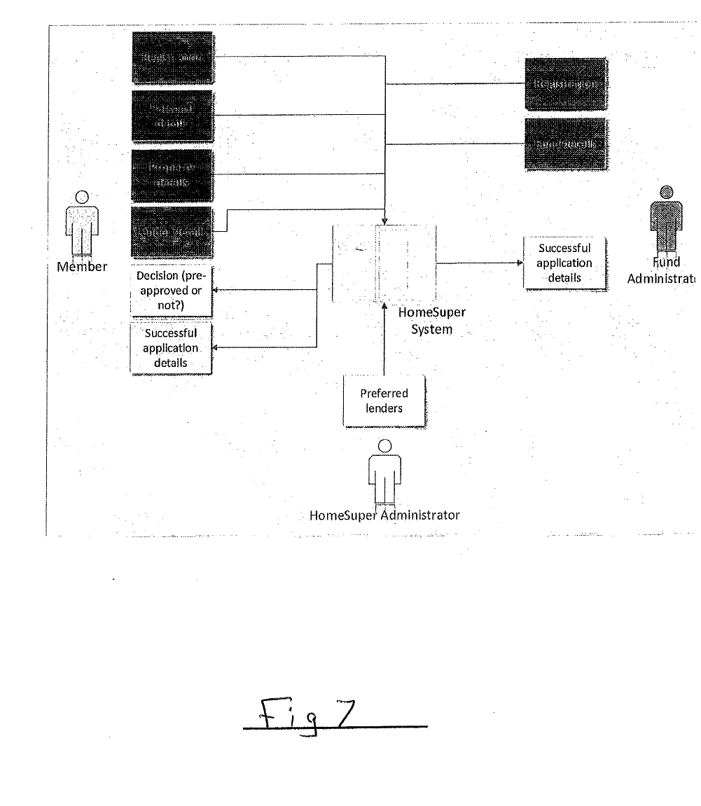

With reference to FIGS. 6 to 10, there is described below a specification for an implementation for the current Australian market of embodiments of the system previously described including reference to data input flow and data output flow. With particular reference to FIG. 6, there is illustrated a process diagram for this implementation wherein, in this instance (as compared with the processed diagrams of FIGS. 2 and 3), the property the target of transaction is yet to be purchased. The process otherwise broadly follows the processes previously described with respect to FIGS. 2 and 3.

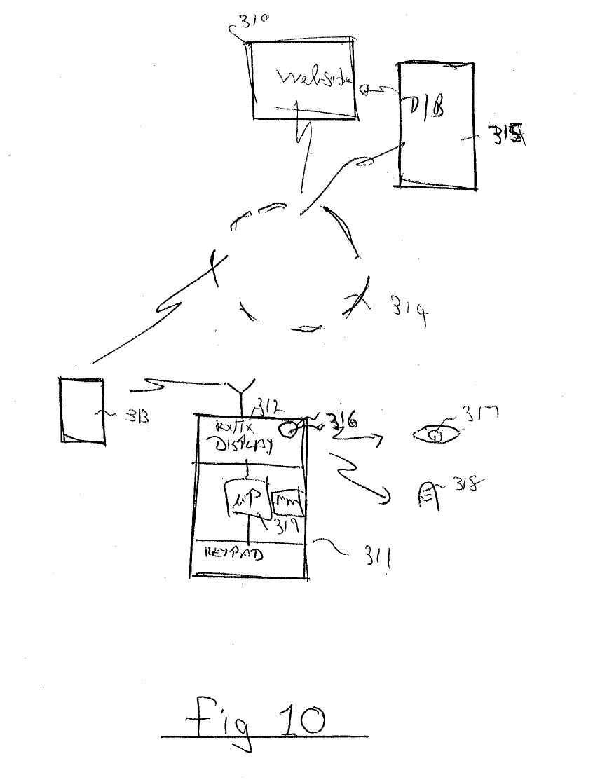

This particular implementation is termed ‘HomeSuper’ in the description which follows. It includes a specification of preferred technical requirements and also, with particular reference to FIG. 10, a hardware enrolment implementation suited for use with the implementation.

Introduction

‘HomeSuper’ a new superannuation investment product which allows any property buyer to use their super fund to invest in the capital value associated with a residential property within Australia.

Scope

The following items are in scope
Access and registration for members and fund administrators
Screens for data entry from members and fund administrators
Application management for members and fund administrators (save, resume, view and cancel investment requests)
Ability to generate real time decisions
Notifications (email and SMS)
Printer friendly screens
Expresso (a trade mark of TSWG Financial Services ICT) onboarding technology for user identification purposes
Access for Lenders/Financial Institutions into the system
Integration with title registry offices and PEXA
Integration with super fund back end processing systems
Documentation reading (Image recognition) and upload/storage capabilities

User types

| User | Description |
|---|---|
| Fund Administrator | An end user of the system who configures the |
| | product and manages the application requests |
| | to their fund. |
| Property Buyer/Super | An end user of the system who has access to |
| Member | lodge application requests to their fund and |
| | view a request currently in progress/already |
| | pre-approved. |
| HomeSuper | The system administrator of the solution who is |
| Administrator | responsible for user management and general |
| | system maintenance. |

Functional Administrators

### Fund Administrators

| ID # | Function | Description |
|---|---|---|
| 1.1 | Fund | Require a fund administrator to register and login to the system. |
| | Registration & | The registration process will include: |
| | Login | Terms and Conditions acceptance |
| | | Account creation |
| 1.2 | Product | Create and configure a HomeSuper product for members. E.g. |
| | Management | Set the rules governing the maximum investment amount, etc. |
| 1.3 | Application | Manage and review application requests lodged in the system. |
| | Management | This will include the ability to: |
| | | View/search through current pre-approved applications |
| | | Close/cancel application requests |
| | | Perform ongoing maintenance of completed applications |
| 1.4 | Reporting | Export data for analysis and reporting |
| 1.5 | Un-Register | Provide the ability to un-register a fund |

Members

| ID # | Function | Description |
|---|---|---|
| 2.1 | Member | Require a member to register and login to the system before they |
| | Registration & | can create an application request. The registration process will |
| | Login | include: |
| | | Terms and Conditions acceptance |
| | | Account creation |
| 2.2 | Manage | Allow a member to enter personal, property and lender |
| | Application | information during different stages of the application process. |
| | Request | Also allow a member to view, save and print application details at |
| | | any stage of the application process. |
| 2.3 | Un-register | Provide the ability for a user to un-register |

HomeSuper Administrators

| ID # | Function | Description |
|---|---|---|
| 3.1 | User | Allow a system administrator to perform user management tasks |
| | Management | for members and fund administrators. This can include password |
| | | resets, account lockouts and first level support. |
| 3.2 | Manage Lender | Ability for a system administrator to add/modify and delete |
| | Details | preferred lender/financial institution details. |
| 3.3 | Analysis & | Allow system data to be exported for analysis and reporting |
| | Reporting | |

Systems Process

| ID # | Function | Description |
|---|---|---|
| 4.1 | Decision | Provide real time decisions to a member regarding member and |
| | Making | property eligibility. |
| | | If a member/property doesn't meet certain criteria the process |
| | | ends. Details of the decision to be shown to the member. |
| 4.2 | Notifications | Ability to send notifications (email or SMS) to members and/or |
| | | fund administrators. Members to receive emails or SMSs when |
| | | they have registered successfully and their application request has |
| | | been pre-approved. Fund administrations to be notified when an |
| | | application has been pre-approved and/or has been updated. |
| 4.3 | Contact Fund | Provide a function to allow the member to contact their fund in |
| | | relation to their application |
| 4.4 | Help | Provide intuitive assistance to users to guide them through the |
| | | system |
| | | Provide links to supporting documentation on the website, |
| | | FAQ's, etc. |
| | | Provide a ‘Contact Us’ channel |
| 4.5 | Secure | Provide a secure ‘Forgot my password’, password retrieval |
| | Password | function |
| | management | Provide a secure Password Reset function |

Non Functional Requirements Security

| ID # | Function | Description |
|---|---|---|
| 5.1 | Authentication | The system must ensure that only authenticated users can |
| | | access it |
| 5.2 | Authorization | The system must clearly define and enforce authorization |
| | | levels for all user types |
| 5.3 | Auditing | Effective auditing must be provided to ensure non- |
| | | repudiation |
| 5.4 | Confidentiality | The system must ensure that each users data remains private |
| 5.5 | Integrity | The system must ensure that all data is protected from |
| | | modification in storage and in transit |
| 5.6 | Availability | The system must remain available for legitimate users, e.g. be |
| | | protected from denial of service attacks |

Performance

| ID # | Function | Description |
|---|---|---|
| 6.1 | Responsiveness | The system must ensure that the pages are served |
| | | within the agreed response time |
| 6.2 | Scalability | The system must be capable of scaling to handle |
| | | load within the pre-determined parameters |

Data Flows

At a high level the following data inputs and outputs exist for the HomeSuper System

Data Inputs

Data inputs to the system can be differentiated between members and fund administrators as follows.

| | | | HomeSuper |
|---|---|---|---|
| | Member | Fund Administrator | Administrator |
| Registration | Username | Username | |
| | Password and/or retina | Password | |
| | scan | Fund Name | |
| | Full Name | Email address | |
| | Date of Birth | Contact name and/or | |
| | Email Address | department name | |
| | Mobile Number | Postal address | |
| Personal | Super Fund Name | | |
| Details | (select from drop down | | |
| | list) | | |
| | Super Fund | | |
| | Membership Number | | |
| | (if applicable) | | |
| | Current Super Balance | | |
| | Investment amount | | |
| | they wish to borrow | | |
| Property | Address of Property | | |
| Details | (they wish to invest in) | | |
| | Land Valuation of | | |
| | Property | | |
| | Valuation Date | | |
| Lender | Lender/Financial | | |
| Details | Institution Name | | |
| Fund Details | | Product/Investment | |
| | | option | |
| | | Acceptance Criteria | |
| Preferred | | | Lender/Financial |
| Lenders | | | Institution Name |
| | | | Contact Details |

Data Outputs

Data outputs from the system can be differentiated for members and fund administrators as follows.

| | Member | Fund |
|---|---|---|
| Decision | Successful/Not Successful | |
| | Investment amount member is pre- | |
| | approved for | |
| Successful | Application Reference Number | Application Reference Number |
| applicant details | URL to access System | List of entities on title |
| | List of entities on title | Member Name |
| | List of Preferred Lenders | Member Email Address |
| | Fund Name | Member Contact Number |
| | Fund Contact Name | Member Super Fund Member |
| | Fund Contact Number | Number |

Workflows

Member/Fund Administrator Registration

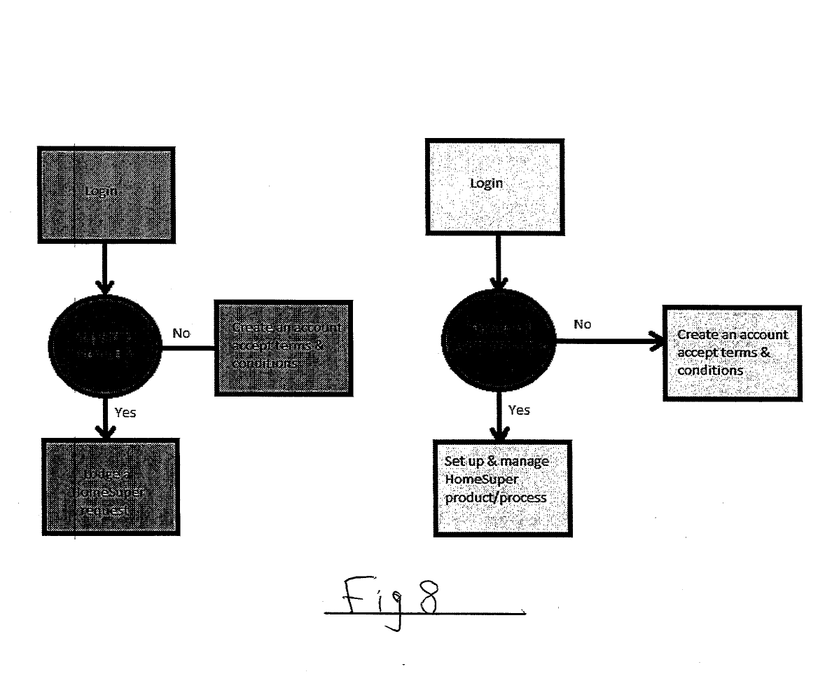

With reference to FIG. 8, there is an illustrated flow chart of a member/fund administrator registration process.

The first time a member logs into the system they will need to register. After registering the member can then lodge a request for a HomeSuper investment.

For a fund administrator, they will need to register before they can setup a HomeSuper product.

Member Requests a HomeSuper Investment

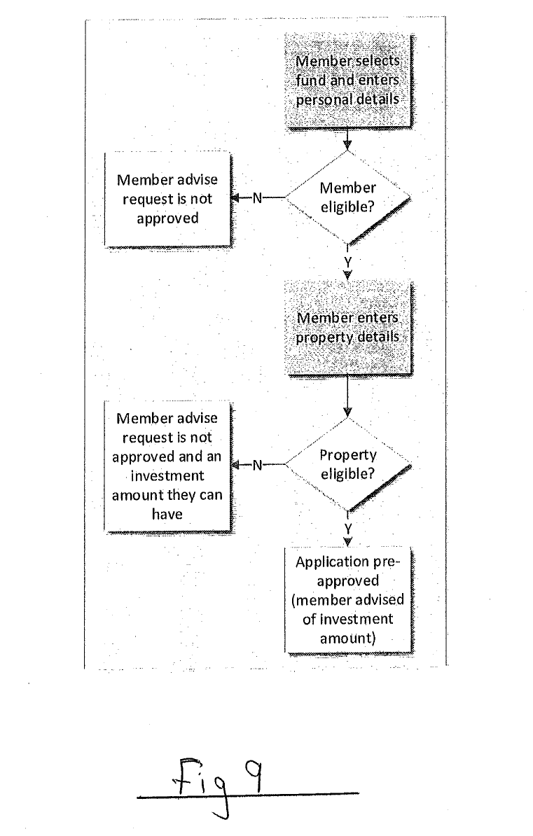

FIG. 9 illustrates an application request process in relation to the implementation.

A member will be required to enter specific personal details so the system can determine if they're eligible for an investment. If they meet the criteria they will also need to enter the property details so a decision can be made on the maximum investment value the member is eligible for. If this calculated amount matches or exceeds the amount the member has requested the application is automatically pre-approved.

With reference to FIG. 10, access to an application sequence on the web site 310 is provided to members of the retirement fund through the log on security of predefined user name and pass code.

With particular reference to FIG. 10, there is illustrated a digital input/output device 311 which, in this instance, incorporates a receiver transmitter 312 which permits it to communicate over a telephone network 313 and via internet 314 to the website 310 operating with conjunction with database 315. In this instance, the digital input/output device 311 includes a camera 316 which, on command, can take an image or scan of a retina 317 of a member or a finger scan of the finger 318 of the member for processing by microprocessor and memory combination 319 in order to verify the identity of the member preparatory to permitting the member to avail themselves of the services of the system of the implementation.

The implementation may incorporate other forms of user security access (retina recognition for example) as alternative means to implement the “pass code”.

The digital input/output device 311 can take an image or scan documents or another image for the purpose of obtaining data for transaction requirements. This data may be read by image recognition software and/or other persons for further verification purposes.

This process may also be undertaken using image scanners at points 10, 12, 13 & 14 in FIG. 1.

Screens

Members will need access to screens to allow them to perform the following:
Register/Login
View/Edit My Personal Details
Start a new application request
View/Edit my requests
Contact Fund
Contact HomeSuper

Fund Administrators will need access to screens to allow them to perform the following:
Register/Login
View/Edit My Fund Details
Add/Edit a HomeSuper product on offer
View/Edit all application requests submitted to their fund
Cancel/close an application request
Contact HomeSuper

HomeSuper Administrators will need access to screens to allow them to perform the following:
Maintain a list of preferred lenders

Provide user management for members and fund administrators.

1.-51. (canceled)

52. A digital input/output device incorporating means to recognise a physiological feature of a prospective member preparatory to comparing that physiological feature with a database of physiological features for verification of the identity of the member thereby to permit access by the member to an electronic management system.

53. The device of claim 52 wherein the electronic management system further comprises of digital processors, database storage medium and input and output devices; said system executing software steps in the management of transactions between financial entities; said financial entities including at least an owner/s of a property (prospective or actual), a retirement fund of said owner/s and an associated managed fund; said transactions including application by said owner/s for an acquisition by said managed fund of investment equity in said owner/s' property.

54. The device of claim 53 wherein said owner/s' property is the personal residence of said owner/s.

55. The device of claim 53 wherein said associated managed fund is an entity incorporated within said retirement fund.

56. The device of claim 53 wherein said associated managed fund is a separate entity.

57. The device of claim 53 wherein said electronic management system is hosted by said retirement fund of said owner/s.

58. The device of claim 53 wherein said electronic management system is shared between said retirement fund and said associated managed fund; said elements of said system hosted by said associated management fund executing steps of complementary software.

59. The device of claim 53 wherein said system generates and transmits suitable application input forms to the owner/s over said distributed communication network as pages of a web site maintained by said system.

60. The device of claim 53 wherein access to an application sequence on said web site is provided to members of said retirement fund through log on security of predefined user name and pass code.

61. The device of claim 53 wherein said application input forms completed by a owner/s are received by said owner/s retirement fund for processing.

62. The device of claim 53 wherein application input form data is structured so as to allow automatic processing by said system; software steps executed by said system including provision of checks with error and advice messages to ensure that application data input by an applicant owner/s conforms to that required to effect a valid application.

63. The device of claim 53 wherein said application input forms provides for additional comments by said applicant owner/s; said software generating an alert to ensure perusal of such non standard or unstructured comments by an operative of said retirement fund.

64. The device of claim 53 wherein data provided by said owner/s in said application forms is vetted by said software to check that said owner/s is an eligible applicant.

65. The device of claim 53 wherein an acceptable application causes said software to generate and transmit to said managed fund a request for equity acquisition by said associated managed fun in said owner/s' property.

66. The device of claim 53 wherein software relevant to said managed fund generates instructions to an investment valuation and verification service for a due diligence and valuation assessment of said owner/s' property.

67. The device of claim 66 wherein said software generates and transmits to said investment valuation service structured assessment input forms which allow substantially automatic processing of assessment data provided by a due diligence and valuation process.

68. An electronic management system comprising of digital processors, database storage medium and input and output devices; said system executing software steps in the management of transactions between financial entities; said financial entities including at least a owner/s of a property, and a retirement fund of said owner/s; said transactions including application by said owner/s for an acquisition by said retirement fund of investment equity in said owner/s' property.

69. The system of claim 68 wherein said financial entities further include an associated managed fund.

70. The system of claim 68 wherein said owner/s' property is the personal residence of said owner/s.
